(19) United States
(12) Patent Application Publication
(10) Pub. No.: US 2003/0035179 A1
(43) Pub. Date: Feb. 20, 2003

(54) Chromatic dispersion characterization

(75) Inventor: Gregory Dean May, Ottawa (CA)

Correspondence Address: Norman P Holoway PC, 130 W Cushing Street, Tucson, AZ, 85701, US

(73) Assignee: Innovance Networks

(21) Appl. No.: 09/932,152

(22) Filed: Aug. 17, 2001

(51) Int. Cl. H04B 10/00; H04B 10/04

(52) U.S. Cl. 359/161; 359/180

(57) ABSTRACT

A chromatic dispersion characterization system for an optical transmission path is based on setting the operating point (the DC bias) of an external modulator alternatively on the inverting and non-inverting characteristic of the modulator. A dispersion regime of choice may be selected based on the modulator's alpha parameter, and the BER information recorded against the respective values of the DC bias. This system can be used to determine when the net CD in a link is zero, i.e. the network provider has provisioned sufficient compensation to match the CD in the link. The link operates in a zero-dispersion regime when the quality of the received signal does not change between the two modes.

### FIELD OF THE INVENTION

The invention resides in the field of optical telecommunications networks, and is directed in particular, to a chromatic dispersion characterization method and apparatus.

### BACKGROUND OF THE INVENTION

The degradation suffered by a signal along a transmission path is due to such factors as channel noise (thermal noise, interference from other users, circuit switching transients, etc.) and inter-symbol interference (a band-limited channel spreads the pulses. For transmission speeds over 2.5 Gb/s, signal corruption caused by Chromatic Dispersion becomes a very important consideration. Chromatic Dispersion (CD) is the dependence of the speed of light on its frequency (wavelength). This frequency dependence can be found in optical fiber and fiber optic components in general. The frequency components within a modulated optical signal travel at different speeds through a medium because of CD. This results in different arrival times for the frequency content at a receiver, which in turn causes distortion and inter-symbol interference in the signal.

It is important to know the magnitude and origin of CD, so that appropriate methods of compensating its effects may be applied to the transmission link. The CD characteristic is quantified in delay (picoseconds) per nanometer of wavelength and per km of fiber length. The CD characteristic of a fiber is often used to estimate the net CD of a transmission link of a network, by multiplying this number with the length of the link in km. For example, the CD characteristic of standard single mode fiber (SMF) is approximately 17 ps/nm/km, so 100 km of this fiber would have a net CD of 1700 ps/nm.

CD compensation is realized by installing devices with a net CD (ps/nm) in the opposite sense. For example, if a network provider wishes to compensate for 1700 ps/nm of CD for a particular wavelength or a set of wavelengths, it can purchase a dispersion compensator that has −1700 ps/nm of CD in the same wavelength regime. The net CD after the compensator is zero, which essentially means that no distortion will occur to a signal because of CD. Sometimes the network provider will compensate the net dispersion to a non-zero value.

While multiplying the CD characteristic by the fiber length is a satisfactory estimation method for low capacity fiber optic systems, it becomes too imprecise as the signal rate increases and more signals are accommodated along the same link as in the case of wavelength division multiplexing (WDM and dense WDM) transmission, because it is difficult to closely match the CD with appropriate compensators. With the different types fiber that could make up a given network, transmission rates surpassing 2.5 Gb/s, fiber optic devices which in turn add further CD to a link, and emerging photonic switching, the estimation technique is inadequate and direct measurement is required. It is also useful to directly measure CD after the compensation is in place to ensure that the appropriate match has been found.

There are currently a number of instruments available on the market that can be used to directly measure CD. However, these require a fiber optic transmission system to be unplugged in order to make the measurement. Also they require further capital to be invested to purchase the lab equipment, trained staff, and transportation of the equipment to a site to make a measurement. It is therefore highly desirable to employ a technique within the fiber optic transmission equipment itself to measure CD.

### SUMMARY OF THE INVENTION

It is an object of the present invention to provide a chromatic dispersion characterization of a transmission path that can be implemented within the fiber optic transmission equipment itself. This invention is particularly useful to determine when the net CD in a link is zero, i.e. the network provider has provisioned sufficient compensation to match the CD in the link.

Accordingly, the invention is directed to a method for characterizing chromatic dispersion of an optical transmission link between a transmitter and a receiver, comprising: providing the transmitter with an external modulator with a fixed alpha parameter; operating the modulator alternatively in a non-inverting mode and an inverting mode for transmitting an optical signal to the receiver; and, for each mode, measuring the quality of said optical signal at said receiver.

Another aspect of the invention is concerned with a method for characterizing chromatic dispersion of an optical transmission link between a local transmitter and a far-end receiver, comprising: providing said transmitter with an external modulator having a fixed chirp; setting a first DC bias for operating said modulator on the non-inverting slope of the transfer characteristic and transmitting a data signal modulated over a channel wavelength to said receiver; measuring a quality parameter of said data signal recovered by said receiver, and storing said first DC bias against a first measured value of said quality parameter; setting a second DC′ bias for operating said modulator on the inverting slope of the transfer characteristic; measuring said quality parameter of said data at said receiver, and storing said second DC′ bias against a second measured value of said quality parameter; and storing said first and said second values to provide chromatic dispersion regime records.

According to a further aspect, the invention provides a controller for controlling operation of an optical transmission link established between a transmitter and a receiver, comprising: at said transmitter, a mode controller for controlling the bias of a modulator provided with a fixed alpha, to alternate between a first DC bias and a second DC′ bias; and at said receiver, a signal quality detector for determining a quality parameter for a data signal received over said transmission link, for both said first bias and said second bias.

Advantageously, the chromatic dispersion characterization according to the invention does not require additional test equipment resulting in a more economical solution.

### BRIEF DESCRIPTION OF THE DRAWINGS

The foregoing and other objects, features and advantages of the invention will be apparent from the following more particular description of the preferred embodiments, as illustrated in the appended figures, where:

FIG. 1A shows the block diagram of a single-drive external modulator (Mach-Zehnder Interferometer);

FIG. 1B shows the block diagram of an external modulator operating in a push-pull mode;

FIG. 1C illustrates how the modulator of FIG. 1A or 1B modulate the data signal over a carrier wavelength;

FIG. 2 illustrates an embodiment of a transmitter terminal according to the invention; and

FIG. 3 shows a flowchart of the method of chromatic dispersion characterization according to one embodiment of the invention.

### DETAILED DESCRIPTION OF THE PREFERRED EMBODIMENTS

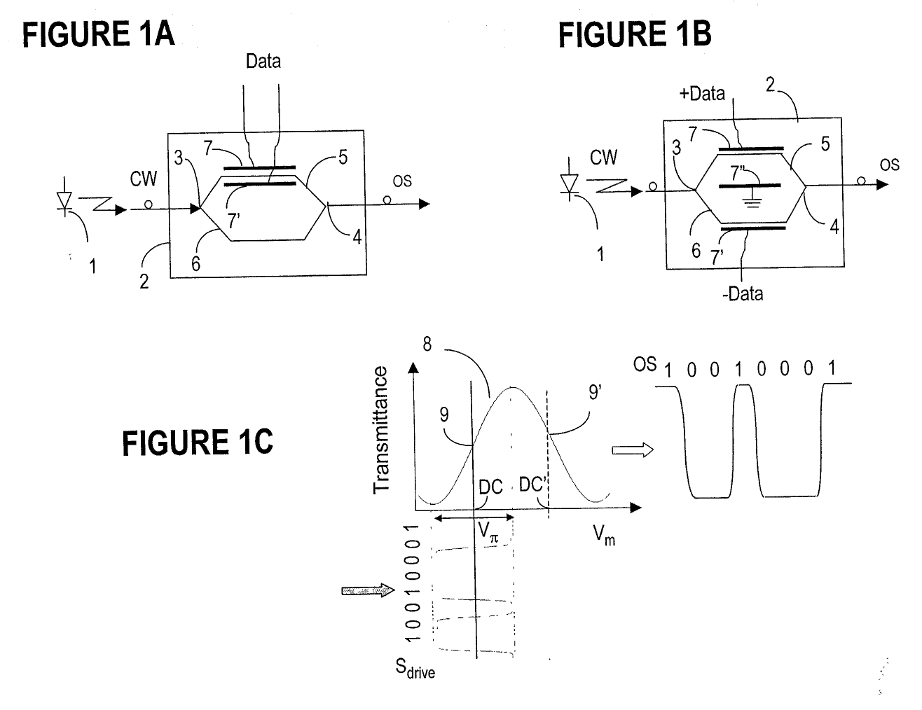

FIGS. 1A and 1B show the block diagrams of external modulators 2. DWDM communication systems use preferably external modulation for achieving high transmission rates over long distances. An external modulator, such as a Mach-Zehnder modulator 2 of FIGS. 1A and 1B, employs a waveguide medium whose refractive index changes according to an applied electrical field (i.e. a driving voltage). In a Mach-Zehnder configuration, two optical interferometer paths 5, 6 are provided, and an incoming optical carrier generated by an optical source, such as a continuous wave laser 1, is split between the two paths as shown at 3. In the absence of a net phase difference in the paths, the optical fields in the two paths interfere constructively at the output, as shown at 4. When a phase difference in the paths occurs, the optical fields in the two paths interfere destructively. The destructive interference can reach a level where virtually no light appears at the output. Voltages applied at electrodes 7, 7′ affect the refractive index of the arms and hence the phase of the light. Therefore, a voltage modulating signal can modulate the light if it is conditioned to produce the appropriate constructive and destructive interference.

The drive voltage, which controls the differential phase shift, is conventionally supplied to one arm (single arm drive) shown in FIG. 1A, or to both arms (dual arm drive), shown in FIG. 1B. The amount of voltage applied to each arm influences the phase shift in each arm. The combination of phase shifts results not only in modulation due to constructive or destructive interference, but also frequency shift in the optical signal as the interference state changes. This frequency shift associated with the change of output state of the modulator from ‘on’ to ‘off’ (or from ‘off’ to ‘on’) is known as chirp. The degree of chirp is related to the imbalance in phase shift between the arms. The chirp can be zero if the phase shift between the arms is equal and opposite. This is possible with the push-pull configuration when the applied electric fields are equal and opposite, and in a single voltage drive configuration if the electrode is designed to produce equal and opposite electric fields in the modulator arms.

The frequency shift associated with an optical signal is characterized by an alpha parameter, also known as a linewidth enhancement factor. The frequency shift moves one way (e.g. higher to lower frequency) when the modulator is driven from ‘on’ to ‘off’ and the other way (e.g. lower to higher frequency) when the modulator is driven from ‘off’ to ‘on’. For example, this could be the case with the drive condition shown in FIG. 1C, where the modulator is biased as shown by DC. The opposite chirp sense, i.e. frequency shifts in the opposite direction, can be realized with exactly the same modulator configuration and drive voltage. In this case, a DC′ bias is applied to the electrical signal into the modulator to shift the drive signal from its non-inverting condition 9 right to the inverting condition (opposite slope) 9′.

This also causes the optical signal to be logically inverted, i.e. a ‘1’ in the driving signal S_{drive}=‘1’ results in an ‘0’ optical signal OS=0, and vice versa. This can be corrected with an external inverting logic gate on the electrical signal. An example of a transmitter with switchable chirp polarity is provided in the U.S. Pat. No. 6,091,535 (Satoh) issued on Jul. 18, 2000 and assigned to Oki Electric Industry Co. Ltd. The transmitter described in this patent enables selection of positive or negative chirp, to compensate for the DC drift in the attenuation characteristic of the modulator. An additional circuit selectively inverts the transmitted or the received signal.

The chirp in the transmitted signal results in further optical frequency content which interacts with the net chromatic dispersion of the fiber. For a typical transmission span of a fiber optic system (less than about 120 km), the additional frequency content can result in one of two outcomes at a receiver, relative to a zero chirp signal: a signal that is highly distorted by additional inter-symbol interference, or one that has actually a better quality from a Bit Error Rate point of view. The higher quality signal results from pulse compression. This is because while CD tends to interact with the natural frequency content of a modulated signal to broaden its pulses, the chirp may interact with the CD to cause a pulse compression effect, which actually can combat the tendency of the signal to broaden.

To summarize, any signal which has chirp will have its quality (measured at the receiver) influenced by CD. Furthermore, the change of the chirp (alpha parameter) sign to the opposite sense will have the opposite impact on the quality. Therefore, it is only possible to obtain no impact on signal quality when the chirp parameter is altered if the net CD within the transmission path is zero.

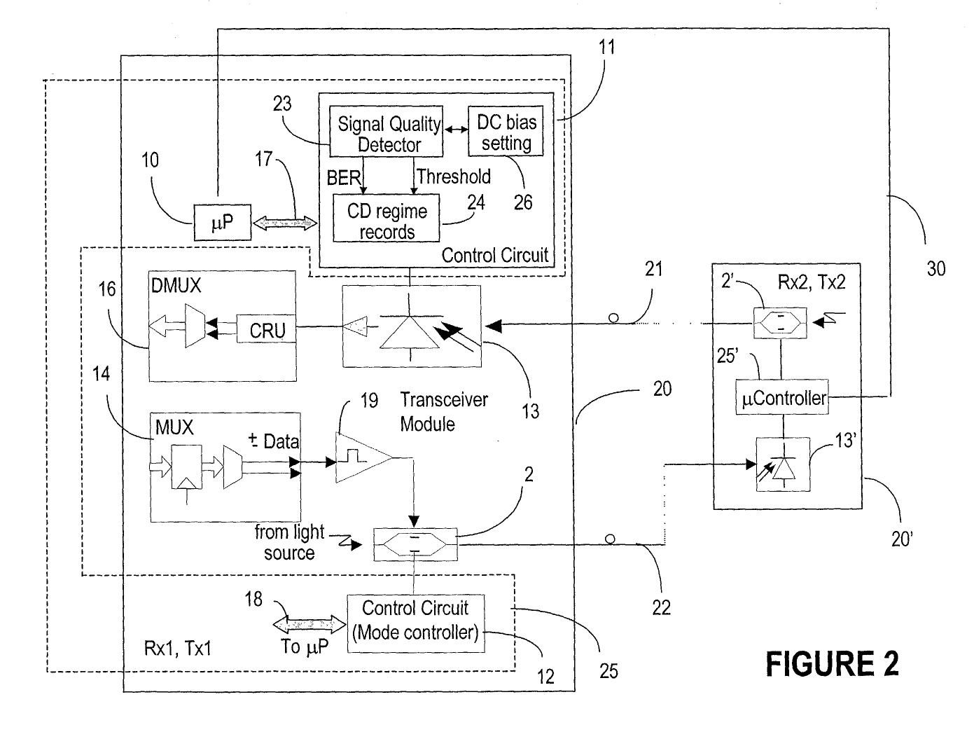

FIG. 2 shows an embodiment of an optical-to-electrical interface (a transceiver module) 20 using the method according to the invention. This interface is contained within a module that converts between a parallel digital electrical signal and a serial fiber optic signal.

The receive side shown in the top part of transceiver 20 comprises a broadband receiver 13 which recovers the data from the incoming optical signal. A control circuit 11 and microprocessor 10 are provided for controlling the operating point of the receiver. Relevant to this invention, controller 11 includes means 23, 24 and 26. Block 23 detects the bit error rate (BER) in the detected signal and is generically defined as a signal quality detector in that it determines the decision threshold of the receiver (both in phase and amplitude) based on the quality of the received signal, in a well-known manner. In general, all modern receivers are provided with means for measuring the quality of the received signal in terms of e.g. a bit error rate BER, a BERV (bit error rate versus voltage), an eye diagram, an eye contour, Q, etc.

The microprocessor 10 sets the DC bias for the transmitter modulator 2, as shown by DC bias setting circuit 26. Microprocessor 10 may also detect when the link operates in a 0-CD regime. Control circuit 11 also includes means for recording the chromatic dispersion regime, shown at 24. It is to be noted that controller 11 may comprise other blocks necessary for operation of receiver 13, but which are not of relevance to this invention.

Bus 17 connects the microprocessor to the control circuit. The demultiplexing circuit 16 converts the serial electrical signal into parallel form. After demultiplexing, the signal has been decomposed into a parallel stream of lower bit-rate signals.

The transmit side shown in the bottom part of module 20 comprises a Mach-Zehnder external modulator 2 and a laser light source (not shown), either internal to the module or external to the module. The modulator 2 is driven in such a way to provide some chirp to the signal. The control circuit 12 is connected to the microprocessor 10 by bus 18 and is responsible, among other functions, with controlling the bias of the modulator in an inverting or non-inverting mode; therefore from this invention point of view, circuit 12 is referred here as the ‘mode controller’. The multiplexer 14 converts a low speed parallel signal into a high speed serial signal (the drive signal). The control circuits 11 and 12 together with microprocessor 10 and the respective buses 17 and 18 delimited by the dotted lines on FIG. 2 are generically referred to as a microcontroller 25.

Note that this application does not require the multiplexer 14 or demultiplexer 16 functions. The key aspects of this design are the external modulator, the receiver, and the control circuit.

Module 20 forms one side of a communication path. The transmitter from this local module is connected to the receiver 13′ of an identical module 20′ at the far end of the path, shown by fiber 22. The receiver 13 from this local module is connected to a transmitter 2 of the far end module, shown by fiber 21. It is to be noted that the traffic in both directions may also be accommodated by a single fiber in a WDM context, but this is not relevant to the invention. The micro-controllers 25 and 25′ have the ability to communicate with each other via an overhead channel, generically shown at 30. It is also to be noted that overhead channel 30 is either contained within the frame payload for the traffic (travelling along the same fibres 21, 22 with the traffic), or supplied externally through some other means.

The process for characterizing the CD of the link is now as shown in FIG. 3 and described next.

The link is put out of service, as shown in step 31, to ensure that the measurement technique does not interrupt live traffic.

The remote receiver 13′ (Rx2) instructs the local transmitter 2 (Tx1) to set the bias DC, step 32, for the non-inverting slope, as shown in FIG. 1C by reference numeral 9.

The remote receiver Rx2 characterizes the incoming signal, step 33. The characterization is preferably in terms of BER, but other parameters indicative of the quality of the received signal may be used, as well known. This can be a single measurement at a fixed decision threshold, or an eye contour (preferred), which measures the BER for a large assortment of thresholds and plots the threshold points where the BER remains the same. The measurement is preferably stored, as shown in step 34. If only one BER measurement is made, it should be done at a decision threshold that results in a non-zero BER.

The remote receiver Rx2 now instructs the local transmitter Tx1 to set the bias DC′, step 35, for the inverting slope, as shown in FIG. 1C by reference numeral 9′. The local transmitter Tx1 also logically inverts the serial electrical signal driving the modulator, so that the signal driving the modulator is identical in logic level to the output optic signal.

The remote receiver Rx2 characterizes the incoming signal as it did in the previous case, step 36. Again, if only one measurement is made, it should be made at the same decision threshold as previously to obtain a non-zero BER. The measurement is again stored, as shown in step 37.

If the receiver signal is identical in quality, as given by the measured quality parameter within the accuracy of the measurement (BER in the example of FIG. 3), decision step 38, it is now known that the chirp in the signal is not interacting with CD to impact the signal quality. This can only occur if the CD is zero within the accuracy of the measurement method, step 40. Therefore, the dispersion compensation has matched perfectly the CD of the fiber plant and/or devices.

If the receiver signal is not identical in BER, the chromatic dispersion is not zero for the respective operating point. If it is desired to compensate the CD, i.e. to match the chromatic dispersion compensation to CD, step 39, the value of the DC bias is changed, step 43, the steps 32-39 are repeated until the matching regime is found. If not, the CD regime is stored, as shown at 41.

It may be possible to use this method to predict a non-zero amount of chromatic dispersion from the stored data, by comparing the quality of the received signal for each chirp regime, step 42.

I claim

1. A method for characterizing chromatic dispersion of an optical transmission link between a transmitter and a receiver, comprising:
providing said transmitter with an external modulator with a fixed alpha parameter;
operating said modulator alternatively in a non-inverting mode and an inverting mode for transmitting an optical signal to said receiver; and
for each mode, measuring the quality of said optical signal at said receiver.

2. A method as claimed in claim 2, wherein said step of providing comprises modulating a channel wavelength with a data signal to obtain said optical signal; and frequency chirping said modulator to obtain said fixed alpha.

3. A method as claimed in claim 1, wherein said step of operating said modulator comprises:
setting a first DC bias on the non-inverting slope of the transfer characteristic for operating said modulator in said non-inverting mode;
measuring a first value of a quality parameter of said optical signal at said receiver;
setting a second DC′ bias on the inverting slope of the transfer characteristic for operating said modulator in said inverting mode; and
measuring a second value of said quality parameter of said data signal recovered by said receiver.

4. A method as claimed in claim 3, further comprising, whenever said modulator operates in said inverting mode, inverting said data signal before modulating said channel wavelength, while the polarity of said alpha depends on said mode.

5. A method as claimed in claim 1, further comprising determining when said transmission link operates in a 0-chromatic dispersion regime.

6. A method as claimed in claim 5, wherein said step of determining comprises:
comparing said first and said second values;
if there is a difference between said first and second values, said transmission link operates with a net chromatic dispersion; and
if there is no difference between said first and second values, said transmission link operates in a 0-chromatic dispersion regime.

7. A method as claimed in claim 2, further comprising storing said first DC bias against said first value and storing said second DC′ bias against said second value to provide chromatic dispersion regime statistics.

8. A method as claimed in claim 7, further comprising predicting a chromatic dispersion regime based on said dispersion regime statistics.

9. A method as claimed in claim 1, wherein said quality parameter is any of an eye diagram and an eye contour of said optical signal recovered by said receiver, a bit error rate BER, a bit error rate versus voltage (BERV) graph and a Q of said data signal recovered by said receiver.

10. A method for characterizing chromatic dispersion of an optical transmission link between a local transmitter and a far-end receiver, comprising:
providing said transmitter with an external modulator having a fixed chirp;
setting a first DC bias for operating said modulator on the non-inverting slope of the transfer characteristic and transmitting a data signal modulated over a channel wavelength to said receiver;
measuring a quality parameter of said data signal recovered by said receiver, and storing said first DC bias against a first measured value of said quality parameter;
setting a second DC′ bias for operating said modulator on the inverting slope of the transfer characteristic;
measuring said quality parameter of said data at said receiver, and storing said second DC′ bias against a second measured value of said quality parameter; and
storing said first and said second values to provide chromatic dispersion regime records.

11. A controller for controlling operation of an optical transmission link established between a transmitter and a receiver, comprising:
at said transmitter, a mode controller for controlling the bias of a modulator provided with a fixed alpha, to alternate between a first DC bias and a second DC′ bias; and
at said receiver, a signal quality detector for determining a quality parameter for a data signal received over said transmission link, for both said first bias and said second bias.

12. A controller as claimed in claim 11, further comprising means for establishing that said transmitter operates in a 0-chromtic dispersion regime whenever a first value of a signal quality parameter measured during said inverting mode is equal with a second value of said signal quality parameter measured during said non-inverting mode.

13. A controller as claimed in claim 11, further comprising means for setting said first DC bias and said second DC′ bias.

14. A controller as claimed in claim 13, further comprising means for communicating said first and said second DC bias from said receiver to said transmitter.

15. A controller as claimed in claim 13, wherein said means for communicating comprises an overhead channel carried within the frame payload for said data signal.

16. A controller as claimed in claim 11, wherein said modulator is an Mach-Zehnder interferometer.

17. An optical transmitter of the type having a light source for providing a channel wavelength and a driving circuit for providing a data signal, comprising:
an external modulator provided with a fixed alpha, for modulating said data signal over said channel wavelength; and
a mode controller for operating said modulator in an inverting mode and an non-inverting mode; and
means for receiving a first DC bias and a second DC′ bias from a remote signal quality detector for enabling said mode controller to alternate operation of said modulator between said respective inverting and non-inverting modes.

18. An optical receiver of the type having an optical-to-electrical detector and a signal quality detector for providing measurements of a quality parameter, comprising means for maintaining chromatic dispersion regime records for an optical communication link.

19. An optical receiver as claimed in claim 18, wherein said receiver further comprises means for setting a first DC bias and a second DC′ bias based on said first and said second values and transmitting said first DC bias and said second DC′ bias to said associated transmitter.
